(19) United States
(12) Patent Application Publication
(10) Pub. No.: US 2023/0077889 A1
(43) Pub. Date: Mar. 16, 2023

(54) AUTOMATIC OBSERVING NET AND UTILIZING METHOD THEREOF

(71) Applicants: Wan-Zhou YU, Yilan County (TW); Ting-Yu CHEN, Yilan County (TW); Hsuan-Chung HUANG, Yilan County (TW); Shun-Qing ZHANG, Yilan County (TW); Yen-Chun TUNG, Yilan County (TW)

(72) Inventors: Wan-Zhou YU, Yilan County (TW); Ting-Yu CHEN, Yilan County (TW); Hsuan-Chung HUANG, Yilan County (TW); Shun-Qing ZHANG, Yilan County (TW); Yen-Chun TUNG, Yilan County (TW)

(21) Appl. No.: 17/475,351

(22) Filed: Sep. 15, 2021

(51) Int. Cl. A01K 61/80; A01K 61/10; G06K 9/00

(52) U.S. Cl. CPC A01K 61/80; A01K 61/10; G06K 9/0063

(57) ABSTRACT

An automatic observing net is provided, and applied in croppers, creatures and cultivation via a feeding and observing equipment, and characterized in comprising a monitoring and identifying system; a feeding equipment control system, connected to the monitoring and identifying system, and including a monitoring data process center, a feeding operation platform, a feeding control center; and a feeding equipment execution system, connected to the feeding equipment control system. A utilizing method of an automatic observing net is provided, and characterized in: the automatic observing net being provided to allow a plurality of feeding and observing equipment to be corresponding to a plurality of cultivating farms for monitoring the cultivation at the same time so to as connect and communicate the data, wherein with a common platform interface, a remote control operation being achieved, the operator only requires to go to the farm when the platform interface sends a requirement.

### BACKGROUND OF THE INVENTION

### 1. Field of the Invention

The present invention relates to an observing net and a method thereof, especially to an automatic observing net and a utilizing method thereof.

### 2. Description of Related Art

In most of the cultivating industries, a standard cultivating means and an automatic equipment are utilized for increasing the harvesting amount of cultivating creatures or croppers, and a cultivating format which can be massively duplicated is established; under the aforesaid situation, there are more and more cultivating industries adopting a modular cultivating status; however, the problem caused by the modular cultivating status has brought back some issues to the cultivating industries; a trend of global cultivating industries (for example: aquaculture, livestock and agriculture) is to greatly increasing the application of automatic machines as a main solution, but a major problem of those machines is that the data cannot be shared; the machines enable a part of the working process to be done by the automatic cultivating operation, but the labor cost still cannot be lowered, because there are more professional people required for maintaining and monitoring the automatic machines, so as to prevent situations, for example the process command being failed to send or the operation being suddenly stopped, from happening; meanwhile, we can review the feeding, which is the most common cultivating process and the most important detail, for illustrations; most of the feeding process is done by labors or machines (for example: automatic feeding machines), if a machine is adopted for feeding, the feeding amount is fixed and cannot be changed once the setting is finished, so that the future feeding operation is unable to alter the feeding amount with respect to the actual cultivating status, and the machine has to be stopped for resetting; as such, the machine itself is unable to timely adjust the feeding amount according to the status of the cultivating creature or cropper, and an operator is needed for adjusting the feeding amount setting stored in the machine, so as to allow the accurate feeding operation to be achieved; accordingly, the existing automatic solution is not suitable to be applied in the cultivating operation in most of the places in the world.

Prior arts are provided as follows. The first prior art is the biological monitoring device of aquaculture cultivation utilizing the cloud; the first prior art discloses a monitoring device, but does not disclose the same device can do both works achieved through utilizing the monitoring device and a feeding device, and also does not disclose both operations of above-water monitoring and feeding can be done at the same time. The second prior art is the remote monitoring system utilizing the deep water immersed tank; the second prior art discloses an underwater monitoring device utilizing a deep water net tank, but does not disclose a function of finishing an above-water monitoring, and also does not disclose the device being provided with a feeding function. The third prior art is the portable underwater monitoring device utilizing the deep water immersed tank; the third prior part discloses an underwater monitoring device utilizing a deep water net tank, but does not disclose a function of finishing an above-water monitoring, and also does not disclose the device being provided with a feeding function. The fourth prior art is the floating type immersed tank; the fourth prior art mainly discloses a floating type net tank, which mainly has functions of increasing the decontaminating function, consuming less energy, having a smaller net which horizontally floats, having a higher tank volume retention rate and increasing the horizontal level of net rank device, but the fourth prior art does not disclose the device being located above the water surface of the fish farm, also does not disclose the net and the platform can be ascended/descended, and can be descended into the fish farm during a feeding operation, and capable of monitoring relevant status and data of the cultivating creature, and also does not disclose being connected to a video capturing device, a net which can be ascended/descended, a platform, a motor and an electric box, and also not disclose a monitoring and identifying system being connected, wherein the monitoring and identifying system has functions of identifying relevant data related to biologic and environment, and cultivating status and feeding equipment control system and providing a cultivating model of cultivating creature and education thereof. The fifth prior art is the cultivating support system of aquaculture, ascending/descending device, feeding device, cultivating method of aquaculture, and cultivating support program of aquaculture; the fifth prior art is an imaging capturing and measuring system for quantity and weight of aquaculture cultivating creature, discloses a device for ascending/descending an observing net and a feeding equipment being provided, and does not disclose a lighting unit being provided for solving a problem of unable to clearly capture images for determining the biological information of aquaculture, and also does not disclose a guiding rail being disposed at the periphery of a structure for preventing vibration during the imaging capturing process, so that the precise biological information cannot be obtained. The sixth prior art is the automatic feeding device, the sixth prior art discloses an automatic feeding device which has devices for feeding, solar power and detecting unit, but the sixth prior art does not disclose a device which can be used without the solar power unit, and also does disclose a monitoring unit for obtaining the biological information, for example, the feeding status and the plant growing rate; however, the monitoring unit of the sixth prior art is only an image capturing lens, and does not disclose a lighting equipment, thus situations of unable to monitor the water quality due to weathers or the sky colors may happen. The seventh prior art is the immersed tank capable of being rapidly ascended/descended; the seventh prior art discloses a net tank capable of being rapidly ascended/descended and capable of mainly adjusting with respect to the sea conditions, the device which can be ascended/descend is disclosed, but does not disclose the device being located above the water surface of the fish farm, also does not disclose the net and the platform can be ascended/descended, and can be descended into the fish farm during a feeding operation, and capable of monitoring relevant status and data of the cultivating creature, and also does not disclose being connected to a video capturing device, a net which can be ascended/descended, a platform, a motor and an electric box, and also not disclose a monitoring and identifying system being connected, wherein the monitoring and identifying system has functions of identifying relevant data related to biologic and environment, and cultivating status and feeding equipment control system and providing a cultivating model of cultivating creature and education thereof. The eighth prior art is the intelligent water quality monitoring system and method; the eighth prior art discloses an intelligent water quality detecting system, wherein a sample piece is used for comparing with standard color pieces for monitoring the water quality status, but does not disclose being located above the water surface of the fish farm, also does not disclose the net and the platform can be ascended/descended, and can be descended into the fish farm during a feeding operation, and capable of monitoring relevant status and data of the cultivating creature, and also does not disclose being connected to a video capturing device, a net which can be ascended/descended, a platform, a motor and an electric box, and also not disclose a monitoring and identifying system being connected, wherein the monitoring and identifying system has functions of identifying relevant data related to biologic and environment, and cultivating status and feeding equipment control system and providing a cultivating model of cultivating creature and education thereof. The ninth prior art is the observing device and the observation managing system; the ninth prior art discloses an observing image device, which can be used for observing croppers or creatures, but does not disclose being located above the water surface of the fish farm, also does not disclose the net and the platform can be ascended/descended, and can be descended into the fish farm during a feeding operation, and capable of monitoring relevant status and data of the cultivating creature, and also does not disclose being connected to a video capturing device, a net which can be ascended/descended, a platform, a motor and an electric box, and also not disclose a monitoring and identifying system being connected, wherein the monitoring and identifying system has functions of identifying relevant data related to biologic and environment, and cultivating status and feeding equipment control system and providing a cultivating model of cultivating creature and education thereof. The tenth prior art is the intelligent immersed tank cultivating system; the tenth prior art discloses an intelligent net tank cultivating system, the net tank has a feeding unit, a water flow sensor, an imaging capturing and lighting device, and does not disclose being capable of providing corresponding treatments for the intelligent feedback for the obtained biological information and the feeding status; accordingly, the above-mentioned disadvantages existed in the prior arts shall be improved, thus the practicability is very much limited and the shortages shall be seriously concerned and improved by the skilled people in the art.

### SUMMARY OF THE INVENTION

For solving the shortages existed in the prior art, one primary objective of the present invention is to provide an automatic observing net and a utilizing method thereof, wherein a monitoring and identifying system, a feeding equipment control system including a monitoring data process center, a feeding operation platform and a feeding control center and a feeding equipment execution system are subsequently connected, for overcoming the shortages existed in the prior arts.

Another objective of the present invention is to provide an automatic observing net and a utilizing method thereof, wherein a monitoring and identifying system is able to constantly and continuously monitor the current status of the cultivating creature and identifying the cultivating cropper and all the data is sent to the feeding equipment control system for providing the real-time adjustment to the feeding settings, and for the cultivating farm where the feeding amount is desired to be controlled or adjusted, the feeding equipment execution system sends an equipment operating and monitoring mode adjustment for finishing the remote feeding control and increasing the adjustable feeding space.

Another objective of the present invention is to provide an automatic observing net and a utilizing method thereof, wherein the operation convenience can be effectively increased, the heavy labor and the issue of hard to manage all the feeding equipment can be improved, and with the whole solution project, the working efficiency of the cultivating personnel can be increased, the cost for managing the cultivating farm and maintaining the feeding equipment can be lowered, and the cultivation feeding and the feeding control can achieve an effect of no time difference with both of the platform performing detection and operation.

Problems to be solved by the present invention are: the first prior art is the biological monitoring device of aquaculture cultivation utilizing the cloud; the second prior art is the remote monitoring system utilizing the deep water immersed tank; the third prior art is the portable underwater monitoring device utilizing the deep water immersed tank; the fourth prior art is the floating type immersed tank; the fifth prior art is the support system of aquaculture, ascending/descending device, feeding device, cultivating method of aquaculture, and cultivating support program of aquaculture; the sixth prior art is the automatic feeding device; the seventh prior art is the immersed tank capable of being rapidly ascended/descended; the eighth prior art is the intelligent water quality monitoring system and method; the ninth prior art is the observing device and the observation managing system; and the tenth prior art is the intelligent immersed tank cultivating system; as such, the practicability is very much limited and the shortages shall be seriously concerned and improved by the skilled people in the art.

For achieving the aforesaid objectives, one technical solution provided by the present invention is to provide an automatic observing net, applied in croppers, creatures and cultivations via a feeding and observing equipment, and characterized in comprising: a monitoring and identifying system, having, but not limited to, a cultivating creature monitoring collecting module and a cultivating creature status identifying module; the cultivating creature monitoring collecting module is used for processing a big data analyze by establishing a monitoring data mode means for relevant data of all the croppers, creatures and cultivation control for providing information of all substance monitoring data; the cultivating creature status identifying module is used for providing an identifying manner and identifying key data from the data obtained through the cultivating creature monitoring collecting module;

a feeding equipment control system, connected to the monitoring and identifying system, and including a monitoring data process center, a feeding operation platform, a feeding control center, wherein a front end of the monitoring data process center is connected to the monitoring and identifying system, the monitoring data process center is used for processing and identifying the data collected by the monitoring and identifying system for data processing and correcting, and allows the feeding operation platform and the feeding control center to process the subsequent storage and access, a front end of the feeding operation platform is connected to a rear end the monitoring data process center, the feeding operation platform takes references of the creature and the cropper statues which are desired to be fed, and the relevant parameters and data of cultivating control, and the feeding operation platform provides a display panel and a feeding operation system to individual personnel with respect to different access levels and reachable information of different users; and the feeding control center is able to provide feeding settings and control parameters through the feeding operation platform;

a feeding equipment execution system, connected to a rear end of the feeding control center of the feeding equipment control system, and served to assist to convert the settings with respect to the feeding settings of the feeding equipment control system into feeding commands which are sent and provided to the corresponding feeding equipment, and served to switch and adjust the operation mode, and to collect the valid data for feedback, wherein the feeding equipment execution system includes, but not limits to, a feeding command control system, a feeding equipment group and operation execution, a feeding result feedback module, the feeding command control system provides a feeding setting to the feeding equipment execution system for controlling whether the corresponding feeding equipment to be operated or stopped, the feeding equipment group and operation execution is connected to the feeding command control system, and served to enable the equipment of the execution command of the feeding command control system, the feeding result feedback module is connected to the feeding equipment group and operation execution, and served to process a data feedback and analyze procedure to the feeding result obtained after the feeding equipment group operation execution is executed;

with the monitoring and identifying system, a current status of the cultivating creature is able to be constantly and continuously monitored and to identify the cultivating creature, and all the data is provided to the feeding equipment control system so as to provide the real-time monitoring and the feeding settings to the feeding equipment control system; for a cultivating farm where a feeding amount is desired to be controlled or adjusted, the feeding equipment execution system sends an equipment operating and monitoring mode adjustment for finishing the remote feeding control and increasing the adjustable feeding space.

Wherein, according to the present invention, a monitoring substance of the cultivating creature monitoring collecting module of the monitoring and identifying system includes, but not limits to, data such as nitrite, vibrio, ammonia, salinity, PH value, dissolved oxygen, temperature, feeds (residual feeds), growth assisting substance in a cultivating farm, water bacteria and alga growth.

Wherein, according to the present invention, the big data analyze of the cultivating creature monitoring collecting module includes, but not limits to, trends and statuses of cropper growing health, operation and status of cultivating machines, environment monitoring, harvesting estimation.

Wherein, according to the present invention, the cultivating creature status identifying module of the monitoring and identifying system includes collecting trending data of identifying appearance of the cultivating creature, growing rate of cultivating creature, daily schedule, habits and habitual behavior, so that the feeding equipment control system is able to be provided with a feeding pattern adjustment and updating data.

Wherein, according to the present invention, the monitoring data process center of the feeding equipment control system includes, but not limits to, data process and operation works, such as a data receiving terminal, a real-time data center, a data correction, a data storage and a data utilization terminal.

Wherein, according to the present invention, a services provides by the feeding operation platform of the feeding equipment control system includes, but not limits to, a feeding monitoring and operation interface, the feeding monitoring and operation interface includes a browser operating interface, a computer software and an intelligent device software.

Wherein, according to the present invention, the feeding control center of the feeding equipment control system includes, but not limits to, a feeding time control, a feeding frequency control, a feeding setting of cultivating farm, a feeding equipment operation setting; so that the direct control and the pre-plan and remote control of the feeding device of the feeding equipment execution system are finished.

Wherein, according to the present invention, the system control of the feeding command control system of the feeding equipment execution system includes, but not limits to, control modes, such as single feeding command sending and terminating or a periodic feeding command sending or terminating, thereby finishing the operation of the feeding equipment.

Wherein, according to the present invention, the equipment of the feeding equipment group and operation execution of the feeding equipment execution system includes, but not limits to, a feeding net observing equipment for the aquaculture cultivating creature, and is able to correspond to the feeding equipment required by the cultivating creature.

Wherein, according to the present invention, the module of the feeding result feedback module of the feeding equipment execution system utilizes processes including, but not limiting to, a feeding result data feedback, a feeding result benefit analyze for visualizing and providing the contents, so that the system operator is able to adjust the feeding settings so as to increase the subsequent feeding result, thereby increasing the quality and the economic benefit of the cultivating creature.

For achieving the aforesaid objectives, one technical solution provided by the present invention is to provide a utilizing method of an automatic observing net, the automatic observing net being provided to allow a plurality of feeding and observing equipment to be corresponding to a plurality of cultivating farms for monitoring the cultivation at the same time so to as connect and communicate the data, wherein with a common platform interface, a remote control operation being achieved, a user does not need to individually feed the plurality of cultivating farms, and does not need to go to the cultivating farm to operate the equipment, and the operator only requires to go to the farm when the platform interface sends a requirement.

Advantages achieved by the present invention comparing to the prior art are as follows. According to the present invention, the monitoring and identifying system, the feeding equipment control system including the monitoring data process center, the feeding operation platform and the feeding control center and the feeding equipment execution system are subsequently connected; accordingly, the monitoring and identifying system is able to constantly and continuously monitor the current status of the cultivating creature and identifying the cultivating cropper, and all the data is sent to the feeding equipment control system for providing the real-time adjustment to the feeding settings, and for the cultivating farm where the feeding amount is desired to be controlled or adjusted, the feeding equipment execution system sends an equipment operating and monitoring mode adjustment for finishing the remote feeding control and increasing the adjustable feeding space; the operation convenience can be effectively increased, the heavy labor and the issue of hard to manage all the feeding equipment can be improved, and with the whole solution project, the working efficiency of the cultivating personnel can be increased, the cost for managing the cultivating farm and maintaining the feeding equipment can be lowered, and the cultivation feeding and the feeding control can achieve an effect of no time difference with both of the platform performing detection and operation; accordingly, the present invention is suitable to be greatly applied in the industrial field and provided with advantages of being novel and non-obviousness.

### BRIEF DESCRIPTION OF THE DRAWINGS

FIG. 1 is a block diagram showing the automatic observing net according to the present invention;

FIG. 2 is a block diagram showing the monitoring and identifying system according to the present invention;

FIG. 3 is a block diagram showing the monitoring data process center according to the present invention;

FIG. 4 is a block diagram showing the feeding operation platform according to the present invention;

FIG. 5 is a block diagram showing the feeding control center according to the present invention;

FIG. 6 is a block diagram showing the feeding equipment execution system according to the present invention;

FIG. 7 is a flowchart showing the operation mechanism of the automatic feeding and observing net of the aquaculture cultivating creature according to the present invention; and

FIG. 8 is a structural view showing the feeding and observing equipment of the present invention.

### BRIEF DESCRIPTION OF THE CODES

1: Monitoring and identifying system
11: Cultivating creature monitoring collecting module
12: Cultivating creature status identifying module
2: Feeding equipment control system
21: Monitoring data process center
22: Feeding operation platform
221: Feeding monitoring and operation interface
23: Feeding control center
3: Feeding equipment execution system
31: Feeding command control system
32: Feeding equipment group and operation execution
33: Feeding result feedback module
4: Feeding and observing equipment
41: Outer cover
42: Motor
43: Observing platform
44: Feeding machine
45: Lighting
46: Bottom shield cover
47: Guiding rail
48: Video capturing equipment
49: Pulling string
491: Electric control box having water level sensor

### DETAILED DESCRIPTION OF THE PREFERRED EMBODIMENT

One preferred embodiment of the present invention will be described with reference to the drawings for illustrating the structural assembly, the technical means and the functions to be achieved by the present invention; and the actual ratios and the arrangement of components shall not be limited by the ratios and the arrangement of components in the provided figures.

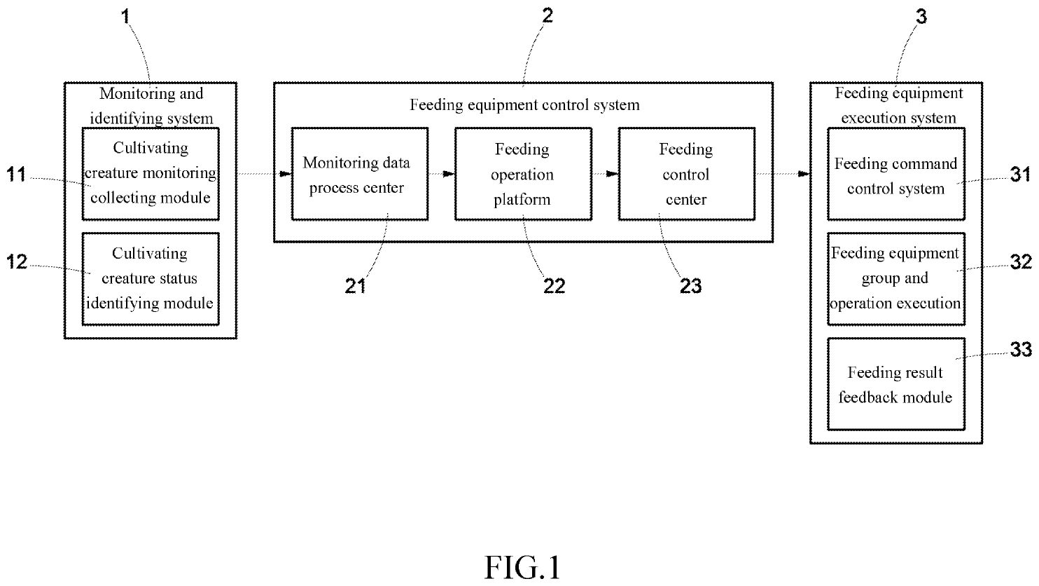

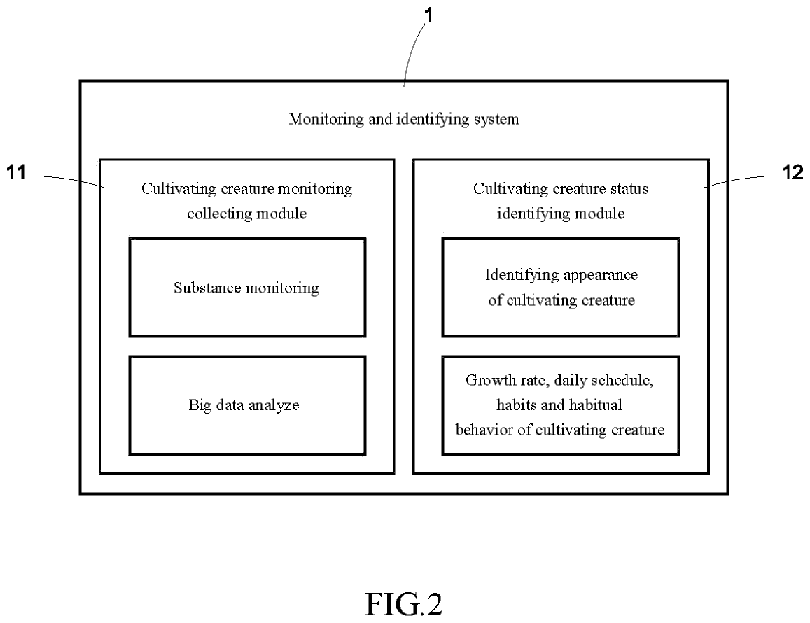

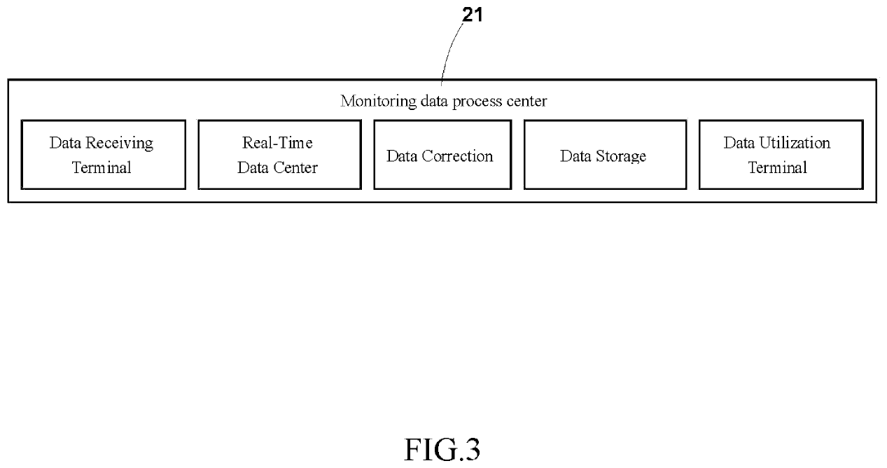

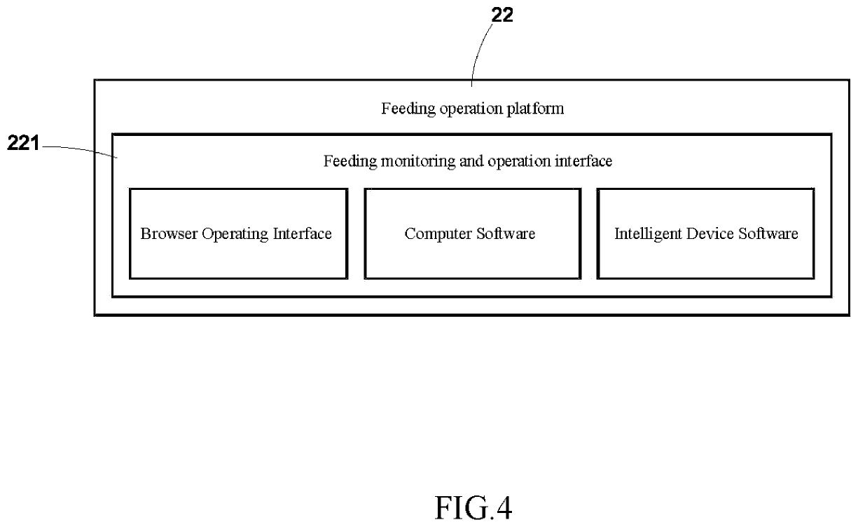

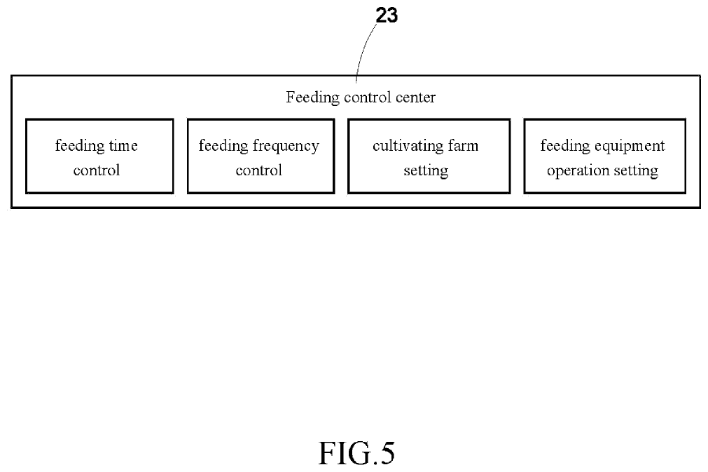

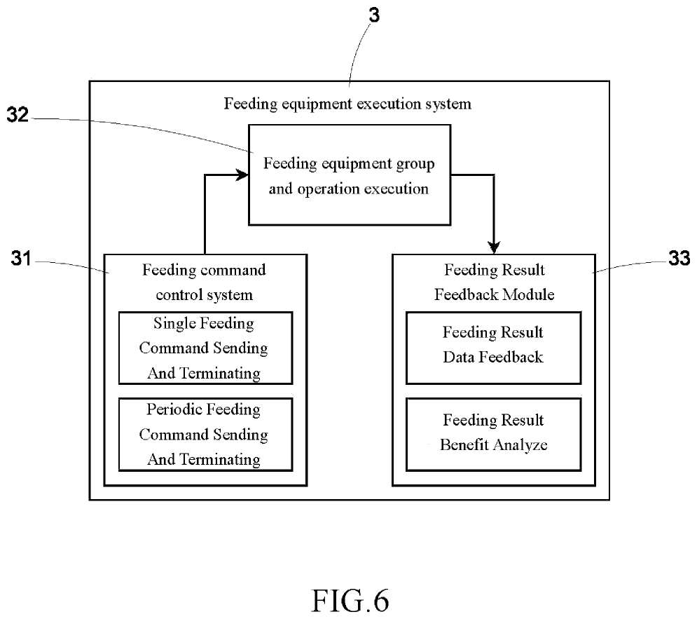

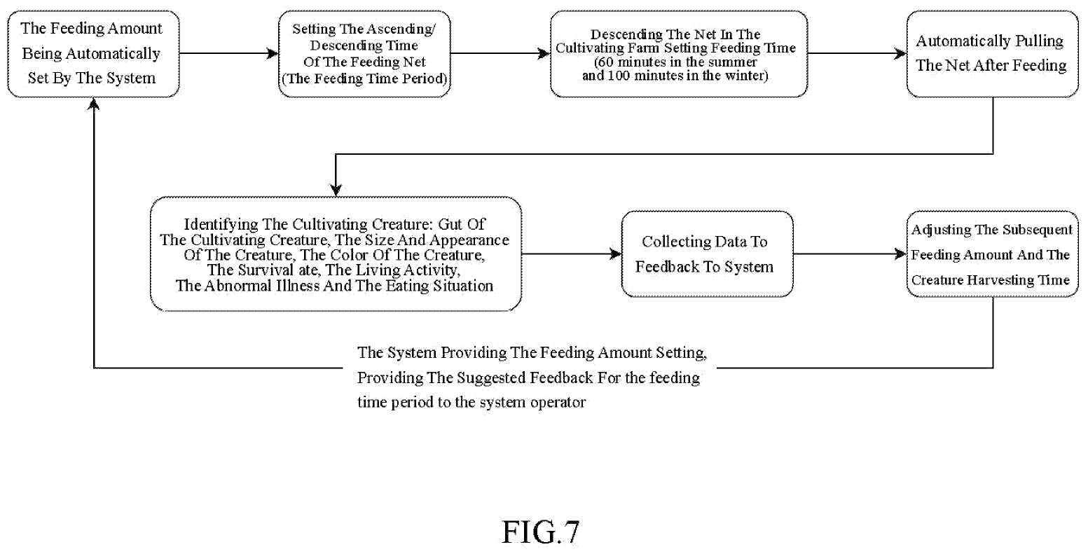

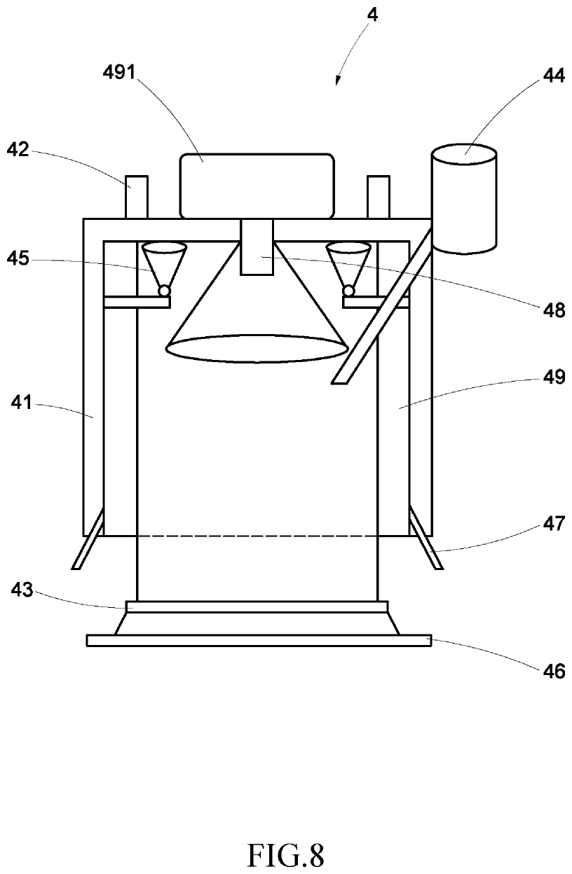

Please refer from FIG. 1 to FIG. 8, wherein FIG. 1 is a block diagram showing the automatic observing net according to the present invention; FIG. 2 is a block diagram showing the monitoring and identifying system according to the present invention; FIG. 3 is a block diagram showing the monitoring data process center according to the present invention; FIG. 4 is a block diagram showing the feeding operation platform according to the present invention; FIG. 5 is a block diagram showing the feeding control center according to the present invention; FIG. 6 is a block diagram showing the feeding equipment execution system according to the present invention; FIG. 7 is a flowchart showing the operation mechanism of the automatic feeding and observing net of the aquaculture cultivating creature according to the present invention; and FIG. 8 is a structural view showing the feeding and observing equipment of the present invention. According to one preferred embodiment of the present invention, an automatic observing net is provided, and applied in croppers, creatures and cultivation via a feeding and observing equipment 4, and characterized in comprising a monitoring and identifying system 1, a feeding equipment control system 2, and a feeding equipment execution system 3.

The monitoring and identifying system 1 has, but not limited to, a cultivating creature monitoring collecting module 11 and a cultivating creature status identifying module 12. The cultivating creature monitoring collecting module 11 is used for processing a big data analyze by establishing a monitoring data mode means for relevant data of all the croppers, creatures and cultivation control for providing information of all the substance monitoring data. The cultivating creature status identifying module 12 is used for providing an identifying manner and identifying key data from the data obtained through the cultivating creature monitoring collecting module 11. The substance monitoring of the cultivating creature monitoring collecting module 11 of the monitoring and identifying system 1 includes, but not limits to, data such as nitrite, vibrio, ammonia, salinity, PH value, dissolved oxygen, temperature, feeds (residual feeds), growth assisting substance in a cultivating farm, water bacteria and alga growth. The big data analyze of the cultivating creature monitoring collecting module 11 includes, but not limits to, trends and statuses of cropper growing health, operation and status of cultivating machines, environment monitoring, harvesting estimation. The cultivating creature status identifying module 12 includes collecting trending data of identifying appearance of the cultivating creature, growing rate of cultivating creature, daily schedule, habits and habitual behavior, so that the feeding equipment control system 2 can be provided with a feeding pattern adjustment and updating data (as shown from FIG. 1 to FIG. 6).

The feeding equipment control system 2 is connected to the monitoring and identifying system 1, and includes a monitoring data process center 21, a feeding operation platform 22, a feeding control center 23. A front end of the monitoring data process center 21 is connected to the monitoring and identifying system 1. The monitoring data process center 21 is used for processing and identifying the data collected by the monitoring and identifying system 1, and allows the feeding operation platform 22 and the feeding control center 23 to process the subsequent storage and access. A front end of the feeding operation platform 22 is connected to a rear end the monitoring data process center 21, the feeding operation platform 22 take references of the creature and the cropper statues which are desired to be fed, and the relevant parameters and data of cultivating control, and the feeding operation platform 22 provides a display panel and a feeding operation system to individual personnel with respect to different access levels and reachable information of different users. A front end of the feeding control center 23 is connected to a rear end of the feeding operation platform 22, and the feeding control center 23 is able to provide feeding settings and control parameters through the feeding operation platform 22. The monitoring data process center 21 includes, but not limits to, data process and operation works, such as a data receiving terminal, a real-time data center, a data correction, a data storage and a data utilization terminal. A services provides by the feeding operation platform 22 includes, but not limits to, a feeding monitoring and operation interface 221, the feeding monitoring and operation interface 221 includes a browser operating interface, a computer software, an intelligent device software. The feeding control center 23 includes, but not limits to, a feeding time control, a feeding frequency control, a feeding setting of cultivating farm, a feeding equipment operation setting; so that the direct control and the pre-plan and remote control of the feeding device of the feeding equipment execution system 3 are finished (as shown from FIG. 1 to FIG. 6).

The feeding equipment execution system 3 is connected to a rear end of the feeding control center 23 of the feeding equipment control system 2, and is served to assist to convert the settings with respect to the feeding settings of the feeding equipment control system 2 into feeding commands which are sent and provided to the corresponding feeding equipment, and served to switch and adjust the operation mode, and to collect the valid data for feedback. The feeding equipment execution system 3 includes, but not limits to, a feeding command control system 31, a feeding equipment group and operation execution 32, a feeding result feedback module 33. The feeding command control system 31 provides a feeding setting to the feeding equipment execution system 3 for controlling whether the corresponding feeding equipment to be operated or stopped. The feeding equipment group and operation execution 32 is connected to the feeding command control system 31, and is served to enable the equipment of the execution command of the feeding command control system 31. The feeding result feedback module 33 is connected to the feeding equipment group and operation execution 32, and served to process a data feedback and analyze procedure to the feeding result obtained after the feeding equipment group operation execution 32 is executed. With the monitoring and identifying system 1, the current status of the cultivating creature can be constantly and continuously monitored and to identify the cultivating cropper, and all the data is provided to the feeding equipment control system 2 so as to provide the real-time monitoring and the feeding settings to the feeding equipment control system 2; for the cultivating farm where the feeding amount is desired to be controlled or adjusted, the feeding equipment execution system 3 sends an equipment operating and monitoring mode adjustment for finishing the remote feeding control and increasing the adjustable feeding space; the system control of the feeding command control system 31 includes, but not limits to, control modes, such as single feeding command sending and terminating or a periodic feeding command sending or terminating, thereby finishing the operation of the feeding equipment; after the command is sent, a feedback of successfully sending or unsuccessfully situation is provided, and an automatic error correcting operation is processed and the system operator is informed, and a corresponding processing procedure is provided (for example: the error code of the equipment is corresponding to “malfunction of the feeding net of the feeding equipment”, a suggestion of correcting the error would be “restarting the equipment, and resending the feeding command”); the equipment of the feeding equipment group and operation execution 32 includes, but not limits to, a feeding net observing equipment for the aquaculture cultivating creature, and is able to corresponding to the feeding equipment required by the cultivating creature; the module of the feeding result feedback module 33 utilizes processes including, but not limiting to, a feeding result data feedback, a feeding result benefit analyze for visualizing and providing the contents, so that the system operator can adjust the feeding settings so as to increase the subsequent feeding result, thereby increasing the quality and the economic benefit of the cultivating creature (as shown from FIG. 1 to FIG. 6).

According to one preferred embodiment of the present invention, one utilizing method of the automatic observing net is that: with the automatic observing net provided by the present invention, a plurality of feeding and observing equipment 4 can be corresponding to a plurality of cultivating farms, so that the cultivations can be monitored at the same time for connecting and communicating the data, with a common platform interface, a remote control operation can be achieved, thus the user does not need to individually feed the plurality of cultivating farms, and does not need to go to the cultivating farm to operate the equipment, and the operator only requires to go to the farm when the platform interface sends a requirement (as shown from FIG. 1 to FIG. 8).

Extended applications of the present invention are provided as follows:

1. Estimating the harvesting time of the cultivating creature: according to the present invention, with respect to the cultivating schedule and the time line working with the historical cultivating data and the feeding related data, an estimation of cultivating creature harvesting time can be provided for allowing the cultivating creature to be sold at the highest commercial value, and the system operator is able to estimate the required time and cost for the harvest; the historical cultivating data and the feeding related data include, but not limit to, the appearance of the cultivating creature, the size of the cultivating creature, the color of the cultivating creature, the weight of the cultivating creature, the eating status of the cultivating creature, the living activity of the cultivating creature, the historical harvesting time and the harvesting amount, meanwhile the system is able to update the systematic harvesting estimation with an algorithm relative to the subsequent and actual cultivating data, and meanwhile a suggested solution of increasing the cultivating efficiency would be synchronously provided.

2. Establishing education model of cultivating means for various of cultivating creatures: according to the present invention, for all the cultivating creatures and croppers, with the feeding operation platform 22 of the feeding equipment control system 2, a visualized cultivating means and a demonstrated education for the croppers can be provided; (for example: according to the present invention, with the cultivating data in each stage and the feeding status of the cultivating creature, the growth schedule and the growth key points of the cultivating creature at each stage can be established, and the education model of the cultivating means for the cultivating creature can also be established).

3. Visualizing the growth schedule model for the cropper: according to the present invention, the feeding operation platform 22 of the feeding equipment control system 2 is able to establish a model of all the details and the biological parameters according to each growth status of the cultivating creature through a daily means including, but not limiting to, a visualizing identifying means, and the biological parameters established via the time line are defined as the possibilities for the user to evaluate whether the filed being suitable to be grow new cropper, and references for determining the growth health can be provided to the bare eyes of the personnel working in the cultivating operation; (for example: according to the present invention, with multiple images of three dimensional model being established, the appearance model of each growth detail of the creature is captured, and a growth model of the cultivating creature corresponding to the time line is established, so as to be recorded and stored in a could).

4. Critical situation warning function: according to the present invention, the monitoring and identifying system 1 is able to divide critical situations into several stages; (for example: a stage one: a general situation; a stage two: a minor critical situation; a stage three: a timely-sensitive critical situation); the different stages of warnings are issued with respect to the sudden situations and great bias from the scheduled arrangement in a short period of time, and the feeding operation platform 22 of the feeding equipment control system 2 is used for sending a message to the system operator, and a suggested processing means is synchronously provided, and relevant data of the sudden situations are also provided (for example: incident content, time of occurring, location, area where the problem happened and contact information of the responsible personnel of the equipment and the situation feedback).

Other functions of the present invention are provided as follows:

1. The automatic feeding observing net of the aquaculture cultivating creature, and the operation mechanism (please refer to FIG. 7):

Firstly, “the feeding amount being automatically set by the system”, and with “setting the ascending/descending time (which is the feeding time period) of the feeding net and setting the descending distance”, and with “setting the feeding time (60 minutes in the summer and 100 minutes in the winter) for descending the net in the cultivating farm”, and with “automatically pulling the net after feeding”, then with “identifying the cultivating creature: gut of the cultivating creature, the size and appearance of the creature, the color of the creature, the survival rate, the living activity, the abnormal illness and the eating situation”, with “the collecting data feedback system”, and with “adjusting the subsequent feeding amount and the creature harvesting time”, lastly with “the system providing the feeding amount setting, providing the suggested feedback for the feeding time period to the system operator” and then back to the “system providing the feeding amount setting”. In other words, the feeding equipment control system 2 provided by the present invention is able to provide illustrations for the feeding operation mechanism of the aquaculture cultivating creature, the operation mechanism is able to monitor the feeding equipment through the automatic feeding observing net of the aquaculture cultivating creature above the water surface and able to be applied in operation above the water surface of the cultivating farm (fish farm); according to the present invention, by automatically setting the feeding amount, the feeding schedule and time, when the time is up, the platform (the net) is descended into the cultivating farm (fish farm), the cultivating creature is captured and the platform (the net) is ascended above the water surface for processing the scheduled feeding; according to the present invention, the feeding time is able to set to be longer or shorter with respect to the seasons (for example: 60 minutes in the summer and 100 minutes in the winter), when the feeding time is up, the platform (the net) is descended into the cultivating farm (fish farm) again, and the platform (the net) is ascended for being above the water surface after the cultivating creature leaves the net, thereby finishing the control of the quantitative and period feeding; with the operation mechanism working with the monitoring and identifying system 1, various parameter situations for identifying the cultivating creature above the water surface of the cultivating farm (fish farm) include, but not limit to, the gut of the cultivating creature, the size and the appearance of the creature, the color of the creature, the survival rate, the living activity, the abnormal illness, and the eating situation, thereby being able to be collected by the collecting data feedback system, and the subsequent feeding amount and the creature harvesting time can be adjusted, thereby increasing the feed conversion rate (FCR) of the cultivating creature, with the minimum interference in the cultivating farm, the feeding mechanism for the aquaculture cultivating creature can be optimized.

2. “The automatic feeding observing net of the aquaculture cultivating creature, and the above-water monitoring and feeding equipment”: (please refer to FIG. 8), the feeding equipment control system 2 is used for the feeding operation mechanism of the aquaculture cultivating creature, illustrations of the corresponding feeding equipment are: one requirement of the feeding equipment corresponding to “the automatic feeding observing net of the aquaculture cultivating creature, and the operation mechanism” is to install a feeding and observing equipment 4 having a bottom end thereof being able to be opened/closed, the feeding and observing equipment 4 itself can be hanged or fastened with other means for being disposed above the cultivating farm (fish farm) of the aquaculture cultivating creature; a motor 42 of an outer cover 41 of the feeding and observing equipment 4 drives the observing net and an observing platform 43 of the feeding and the observing equipment 4 to be descended into the fish farm, the cultivating creature is then captured in the observing net and the observing platform 43, the observing net and the observing platform 43 are ascended with a water level sensing means for entering the outer cover 41 of the feeding and observing equipment 4, thereby enabling a feeding process to be performed; during the feeding process being performed, a feeding machine 44 at an upper right side defined in the outer cover 41 of the feeding and observing equipment 4 is used for feeding, a lighting 45 in the outer cover 41 of the feeding and the observing equipment 4 is actuated, meanwhile a bottom shield cover 46 and a guiding rail 47 are both closed for preventing the interior of the outer cover 41 of the feeding and observing equipment 4 from being affected by the external light, and a video capturing equipment 48 (including, but not limiting to, an infrared video capturing machine or a conventional video capturing machine) for identifying the feeding and the cultivating creature status; after the feeding process is finished, the feeding and observing equipment 4 enables the feeding machine 44 to be descended into the fish farm through a pulling string 49 and an electric control box 491 having a water level sensor, so that the cultivating creature can be released from the feeding machine 44, the lighting 45 is terminated, and the feeding machine 44 is ascended for being located in the outer cover 41 of the feeding and observing equipment 4, lastly the bottom shield cover 46 and the guiding rail 47 are closed, thereby finishing the whole feeding process.

3. “Sharing and browsing real-time information with multiple platform”: according to the present invention, the feeding operation platform 22 of the feeding equipment control system 2 is able to provide corresponding application programs, platform browsing and operating means to various terminal equipment, the terminal equipment includes, but not limits to, an intelligent device (for example a mobile phone or a tablet computer), a computer, a television, a wearable device, or other electronic devices, and the feasible means including, but not limiting to, application programs, websites or audio descriptions corresponding to the terminal device.

4. “Operating by multiple personnel and in multiple cultivating farm and setting data browsing authority”: according to the present invention, the feeding operation platform 22 of the feeding equipment control system 2 is able to enable the system operator and the authorized personnel to set authority setting of browsing and modifying for each authorized personnel, this function is to have a labeling means including, but not limits to, equipment, cultivating farm, management authority, management range and subject for establishing settings of authority for each personnel, and defining the cultivating operation range for the data browsing and accessing corresponding to each personnel.

5. “Suggesting the feeding mechanism and schedule”: according to the present invention, the feeding control center 23 of the feeding equipment control system 2 is able to control the feeding equipment and the sensor which are required to be periodically operated, the present invention is able to provide historical records of commands, and a preset feeding mechanism can be automatically established with respect to thereof for allowing the user to view and adopt, if the user confirms the feeding mechanism which is desired to be operated, the user can adjust the feeding setting in the feeding control center 23 according to his/her own experience, after the adjustment is finished, the setting can be inputted in the feeding command control system 31 of the feeding equipment execution system 3 so as to immediately send the command, and the system operator is able to store the command in a storage space for allowing the command to be used as a rapid and commended command which can be subsequently used and sent by other users.

Advantages achieved by the present invention comparing to the prior art are as follows:

1. According to the fourth extending application of critical situation warning function, when there is error or emergency situation happening in a conventional cultivating equipment, a warning light is used for emitting warning lights or a speaker is used for generating warning sounds to inform the personnel to handle the error or the emergency situation, with the above-mentioned conventional method, if the personnel is not on site or the warning device is in an abnormal status, the warning cannot be successfully generated and the personnel cannot be informed to handle; according to the present invention, the feeding operation platform 21 of the feeding equipment control system 2 is able to directly inform the personnel, which is responsible to the area or the equipment, to handle, so that the dangerous situation of no personnel handling the emergency after happening can be lowered, and the cultivating working and the feeding safety can be increased.

2. According to the fourth other function of operating by multiple personnel and in multiple cultivating farm and setting data browsing authority; in a browsing interface provided by the conventional cultivating equipment or system, there is no concept of managing the browsing authority of the user, thus a physical machinery room is required to be constructed, and the system needs to be managed by the safety staff or the personnel for controlling the personnel and the authority who can access; according to the present invention, the authority of each personnel can be rapidly established in the terminal end, so that the establishing cost for allowing the personnel browsing the data via the hardware equipment in the cultivating farm can be reduced, meanwhile the sensitive data is prevented from being released, the authority setting efficiency for temporally managing personnel can be increased, and the on-board and the training efficiency of the new personnel can be quicker.

3. According to the first other function of the automatic feeding observing net of the aquaculture cultivating creature and the operation mechanism, and according to the second other function of the automatic feeding observing net of the aquaculture cultivating creature and the above-water monitoring and feeding equipment; in a conventional cultivating farm, there is no biological monitoring means and equipment, because the existing system and sensor are both used underwater, only the parameters related to water quality can be detected, and the cultivating creature status is unable to be directly understood; according to the present invention, with the operation mechanism of the aquaculture cultivating creature and with the above-water image identifying means, the images of the cultivating creature can be directly captured for identifying the biological characteristics so as to learn the health status (for example: the color and size of the gut of the shrimp, determining the health level and the time to be waited for harvesting), the operation mechanism is able to determine the health status without the indirect data, the above-water image identification can be used for directly obtaining the data, thereby directly identifying the health status.

According to the present invention, with the aquaculture feeding and observing equipment: the net and the platform can be ascended/descended above the water surface of the fish farm, the net and the platform can be descended into the fish farm during feeding, relevant status and data of the cultivating creature can be monitored; the video capturing machine, the net and the platform can be ascended/descended, the motor and the electric box are provided; the monitoring and identifying system: which can be used for identifying relevant data of biological and environmental and cultivating status; the feeding equipment control system is able to process the monitoring data, corresponding to the result analyze, and capable of being connected to a plurality of terminal equipment; the education of cultivating means for various of cultivating creatures are established.

According to the present invention, the monitoring and identifying system 1, the feeding equipment control system 2 including the monitoring data process center 21, the feeding operation platform 22 and the feeding control center 23 and the feeding equipment execution system 3 are subsequently connected; accordingly, the monitoring and identifying system 1 is able to constantly and continuously monitor the current status of the cultivating creature and identifying the cultivating cropper, and all the data is sent to the feeding equipment control system 2 for providing the real-time adjustment to the feeding settings, and for the cultivating farm where the feeding amount is desired to be controlled or adjusted, the feeding equipment execution system 3 sends an equipment operating and monitoring mode adjustment for finishing the remote feeding control and increasing the adjustable feeding space; the operation convenience can be effectively increased, the heavy labor and the issue of hard to manage all the feeding equipment can be improved, and with the whole solution project, the working efficiency of the cultivating personnel can be increased, the cost for managing the cultivating farm and maintaining the feeding equipment can be lowered, and the cultivation feeding and the feeding control can achieve an effect of no time difference with both of the platform performing detection and operation; accordingly, the present invention is suitable to be greatly applied in the industrial field and provided with advantages of being novel and non-obviousness.

Based on what has been disclosed above, the present invention is novel comparing to prior arts, and achieves effects which are desired to be achieved, and the features of the present invention could be understood by the skilled people in the arts, moreover, the feature of the present invention has not been published and complies with the patentability of novelty, practicability and non-obviousness. As such, the present invention is applied with a hope of being granted so as to contribute to the relative technical fields.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An automatic observing net, applied in croppers, creatures and cultivations via a feeding and observing equipment, and characterized in comprising:
a monitoring and identifying system, having, but not limited to, a cultivating creature monitoring collecting module and a cultivating creature status identifying module; the cultivating creature monitoring collecting module is used for processing a big data analyze by establishing a monitoring data mode means for relevant data of all the croppers, creatures and cultivation control for providing information of all substance monitoring data; the cultivating creature status identifying module is used for providing an identifying manner and identifying key data from the data obtained through the cultivating creature monitoring collecting module;
a feeding equipment control system, connected to the monitoring and identifying system, and including a monitoring data process center, a feeding operation platform, a feeding control center, wherein a front end of the monitoring data process center is connected to the monitoring and identifying system, the monitoring data process center is used for processing and identifying the data collected by the monitoring and identifying system for data processing and correcting, and allows the feeding operation platform and the feeding control center to process the subsequent storage and access, a front end of the feeding operation platform is connected to a rear end the monitoring data process center, the feeding operation platform takes references of the creature and the cropper statues which are desired to be fed, and the relevant parameters and data of cultivating control, and the feeding operation platform provides a display panel and a feeding operation system to individual personnel with respect to different access levels and reachable information of different users; the feeding control center is able to provide feeding settings and control parameters through the feeding operation platform; and a front end of the feeding operation center is connected to a rear end of the feeding operation platform for providing feeding settings and control parameters;
a feeding equipment execution system, connected to a rear end of the feeding control center of the feeding equipment control system, and served to assist to convert the settings with respect to the feeding settings of the feeding equipment control system into feeding commands which are sent and provided to the corresponding feeding equipment, and served to switch and adjust the operation mode, and to collect the valid data for feedback, wherein the feeding equipment execution system includes, but not limits to, a feeding command control system, a feeding equipment group and operation execution, a feeding result feedback module, the feeding command control system provides a feeding setting to the feeding equipment execution system for controlling whether the corresponding feeding equipment to be operated or stopped, the feeding equipment group and operation execution is connected to the feeding command control system, and served to enable the equipment of the execution command of the feeding command control system, the feeding result feedback module is connected to the feeding equipment group and operation execution, and served to process a data feedback and analyze procedure to the feeding result obtained after the feeding equipment group operation execution is executed;
with the monitoring and identifying system, a current status of the cultivating creature is able to be constantly and continuously monitored and to identify the cultivating cropper, and all the data is provided to the feeding equipment control system so as to provide the real-time monitoring and the feeding settings to the feeding equipment control system; for a cultivating farm where a feeding amount is desired to be controlled or adjusted, the feeding equipment execution system sends an equipment operating and monitoring mode adjustment for finishing the remote feeding control and increasing the adjustable feeding space.

2. The automatic observing net as claimed in claim 1, wherein a monitoring substance of the cultivating creature monitoring collecting module of the monitoring and identifying system includes, but not limits to, data such as nitrite, vibrio, ammonia, salinity, PH value, dissolved oxygen, temperature, feeds (residual feeds), growth assisting substance in a cultivating farm, water bacteria, alga growth.

3. The automatic observing net as claimed in claim 1, wherein the big data analyze of the cultivating creature monitoring collecting module includes, but not limits to, trends and statuses of cropper growing health, operation and status of cultivating machines, environment monitoring, harvesting estimation.

4. The automatic observing net as claimed in claim 1, wherein the cultivating creature status identifying module of the monitoring and identifying system includes collecting trending data of identifying appearance of the cultivating creature, growing rate of cultivating creature, daily schedule, habits and habitual behavior, so that the feeding equipment control system is able to be provided with a feeding pattern adjustment and updating data.

5. The automatic observing net as claimed in claim 1, wherein the monitoring data process center of the feeding equipment control system includes, but not limits to, data process and operation works, such as a data receiving terminal, a real-time data center, a data correction, a data storage and a data utilization terminal.

6. The automatic observing net as claimed in claim 1, wherein a services provides by the feeding operation platform of the feeding equipment control system includes, but not limits to, a feeding monitoring and operation interface, the feeding monitoring and operation interface includes a browser operating interface, a computer software and an intelligent device software.

7. The automatic observing net as claimed in claim 1, wherein the feeding control center of the feeding equipment control system includes, but not limits to, a feeding time control, a feeding frequency control, a feeding setting of cultivating farm, a feeding equipment operation setting; so that the direct control and the pre-plan and remote control of the feeding device of the feeding equipment execution system are finished.

8. The automatic observing net as claimed in claim 1, wherein the system control of the feeding command control system of the feeding equipment execution system includes, but not limits to, control modes, such as single feeding command sending and terminating or a periodic feeding command sending or terminating, thereby finishing the operation of the feeding equipment.

9. The automatic observing net as claimed in claim 1, wherein the equipment of the feeding equipment group and operation execution of the feeding equipment execution system includes, but not limits to, a feeding net observing equipment for the aquaculture cultivating creature, and is able to correspond to the feeding equipment required by the cultivating creature.

10. The automatic observing net as claimed in claim 1, wherein the module of the feeding result feedback module of the feeding equipment execution system utilizes processes including, but not limiting to, a feeding result data feedback, a feeding result benefit analyze for visualizing and providing the contents, so that the system operator is able to adjust the feeding settings so as to increase the subsequent feeding result, thereby increasing the quality and the economic benefit of the cultivating creature.

11. A utilizing method of an automatic observing net, characterized in: the automatic observing net being provided to allow a plurality of feeding and observing equipment to be corresponding to a plurality of cultivating farms for monitoring the cultivation at the same time so to as connect and communicate the data, wherein with a common platform interface, a remote control operation being achieved, a user does not need to individually feed the plurality of cultivating farms, and does not need to go to the cultivating farm to operate the equipment, and the operator only requires to go to the farm when the platform interface sends a requirement.
